(19) United States
(12) Patent Application Publication
(10) Pub. No.: US 2009/0070452 A1
(43) Pub. Date: Mar. 12, 2009

(54) INFORMATION PROCESSING APPARATUS, CONTROL METHOD FOR CONTROLLING THE INFORMATION PROCESSING APPARATUS, AND PROGRAM

(75) Inventor: Masaaki Sato, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/208,118

(22) Filed: Sep. 10, 2008

(30) Foreign Application Priority Data
Sep. 11, 2007 (JP) 2007-235844

(51) Int. Cl. G06F 15/173

(52) U.S. Cl. 709/223

(57) ABSTRACT

Functional information about a plurality of workflow executing apparatuses capable of executing a processing flow including a plurality of processing steps is managed by obtaining a first set value information for executing the processing flow in a first workflow executing apparatus, and when a second workflow executing apparatus executes the processing flow, generating a second set value information for the second workflow executing apparatus based on functional information about the second workflow executing apparatus and the first set value information.

### BACKGROUND OF THE INVENTION

1. Field of the Invention

The present invention relates to an image forming apparatus that executes printing based on a print job received from an information processing apparatus.

2. Description of the Related Art

In recent years, a multifunction apparatus having an image forming function has been developed as a multifunction peripheral, which combines the functions of a printer, a copier, a facsimile, etc. To simplify user's work at offices, an increasing number of multifunction apparatuses are capable of executing a plurality of processing steps to be performed therein as a single job.

A workflow (processing flow) is provided depending on the user's work and is a combination of a plurality of processing steps. An administrator of a workflow edits and sets the workflow in a multifunction apparatus. Users typically use preset workflows. Here, a workflow is a combination of a plurality of processing steps involved in work at an office. For example, a workflow is a combination of three processing steps, “document scan→send→print”.

Typically, in response to a predetermined login operation of a user to which a workflow is to be provided, an environment which is different depending on the user is provided to the user. Then typically, when a workflow specifically described is provided to the user's environment, parameter setting is performed for each of a plurality of processing steps in the workflow. For example, a scan value of a scanning apparatus is specified in a document scan process, a destination of transmission is specified in a send process, and a print color is specified in a print process. Parameters involved in each process vary depending on the capability of the image forming apparatus. These parameters are typically provided as selectable values by a pull-down menu or an option list.

There are an increasing number of image forming apparatuses which allow another image forming apparatus to reuse a workflow and a parameter job which have been executed by the user, thereby enhancing user convenience. For example, Japanese Patent Laid-Open No. 2004-112636 discloses a technique in which an image forming apparatus selects an instruction stored in a service processing apparatus so as to execute processing using parameters set in the instruction.

However, in the known technique described above, the image forming apparatus needs to use parameters described in the selected instruction to execute processing. In other words, an error may occur if the set parameters are not suitable for the image forming apparatus.

If parameters are set every time before processing is executed, it may be possible to prevent such an error. However, repeating the same setting operation every time may place a greater burden on the user.

The present invention has been made in view of the circumstances described above. The present invention provides a mechanism which allows an image forming apparatus to properly execute processing without placing a greater burden on the user in setting operation.

### SUMMARY OF THE INVENTION

According to an embodiment of the present invention, an information processing apparatus that communicates with a plurality of workflow executing apparatuses capable of executing a processing flow including a plurality of processing steps includes a managing unit configured to manage functional information about the plurality of workflow executing apparatuses, an obtaining unit configured to obtain a first set value information for executing the processing flow in a first workflow executing apparatus, and a generating unit configured to generate, when a second workflow executing apparatus executes the processing flow, a second set value information for the second workflow executing apparatus based on the first set value information. When the second workflow executing apparatus cannot execute processing corresponding to the first set value information, the generating unit generates the second set value information based on the first set value information and functional information about the second workflow executing apparatus.

Further features of the present invention will become apparent from the following description of exemplary embodiments with reference to the attached drawings.

### BRIEF DESCRIPTION OF THE DRAWINGS

FIG. 1 illustrates a configuration of an information processing system according to an embodiment of the present invention.

FIG. 2 illustrates a configuration of a major part of a copier according to an embodiment of the present invention.

FIG. 3 illustrates a hardware configuration of a scanner and a printer which are illustrated in FIG. 2.

FIG. 4 illustrates a configuration of an operation unit illustrated in FIG. 2.

FIG. 5 illustrates an operation screen displayed in the operation unit of FIG. 4.

FIG. 6 illustrates a configuration of a client computer according to an embodiment of the present invention.

FIG. 7A illustrates a configuration of an image forming apparatus according to an embodiment of the present invention. FIG. 7B illustrates a configuration of an information generating apparatus according to an embodiment of the present invention.

FIG. 8 illustrates a workflow according to an embodiment of the present invention.

FIG. 9 illustrates screens displayed when a workflow is executed according to a default set value.

FIG. 10 illustrates screens displayed when a workflow is executed according to set values specified by a user.

FIG. 11 is a flowchart illustrating a set-value-information providing process according to an embodiment of the present invention.

FIG. 12 illustrates set value information provided in the set-value-information providing process of FIG. 11.

FIG. 13 illustrates an information generating process according to an embodiment of the present invention.

FIG. 14 illustrates an apparatus-capability management table according to an embodiment of the present invention.

FIG. 15 illustrates a workflow management table according to an embodiment of the present invention.

FIG. 16 illustrates set value information generated in the information generating process of FIG. 13.

FIG. 17 is a flowchart illustrating a set-value-information obtaining process according to an embodiment of the present invention.

FIG. 18 illustrates screens displayed when a workflow is executed using set value information generated according to an embodiment of the present invention.

FIG. 19 also illustrates screens displayed when a workflow is executed using set value information generated according to an embodiment of the present invention.

### DESCRIPTION OF THE EMBODIMENTS

Hereinafter, embodiments of the present invention will be described in detail with reference to the attached drawings.

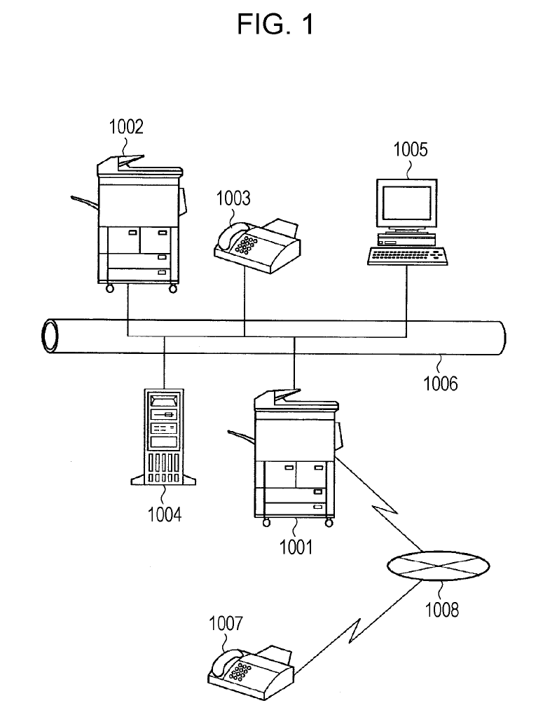

FIG. 1 illustrates a configuration of an information processing system to which an information processing apparatus according to an embodiment of the present invention is applied. The information processing system of FIG. 1 includes a client computer and a multifunction apparatus. The multifunction apparatus of the present embodiment is a copier having a data transmission/reception function.

A copier 1001 is connected, via a local area network (LAN) 1006, to a copier 1002 having a function similar to that of the copier 1001, a facsimile apparatus 1003, a database/e-mail server 1004, and a client computer 1005 such that the copier 1001 can communicate with them. The LAN 1006 is a communication network, such as Ethernet®. The copier 1001 can communicate with a facsimile apparatus 1007 via a public line 1008.

The copier 1001 has a copy function, a facsimile function, and a data transmission function which allows scanning of a document image and transmission of image data obtained by the scanning to each apparatus on the LAN 1006. Additionally, the copier 1001 has a page-description language (PDL) function which allows reception and printing of a PDL image specified by a computer, etc. connected to the LAN 1006.

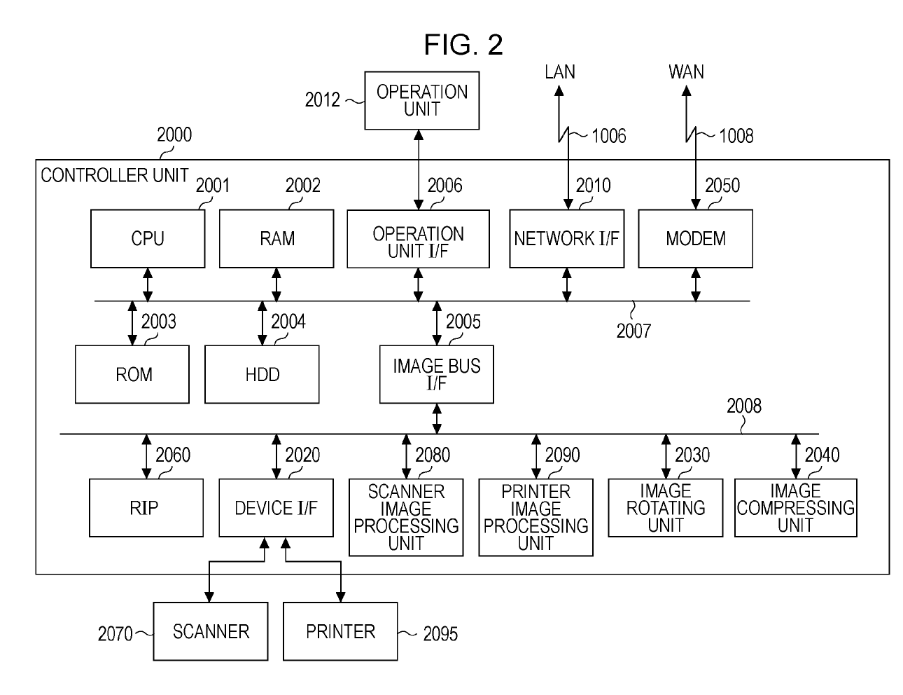

The copier 1001 can store, in a selected box area of a hard disk drive (HDD) 2004 (see FIG. 2) in the copier 1001, an image scanned by the copier 1001 and a PDL image specified by a computer, etc. connected to the LAN 1006. Also, the copier 1001 can print an image stored in the box area.

Additionally, the copier 1001 can receive, via the LAN 1006, data read by the copier 1002, and store the received data in the HDD 2004 of the copier 1001 or print and output the received data. Also, the copier 1001 can receive an image from the client computer 1005 or the database/e-mail server 1004 and store the received image in the copier 1001 or print and output the received image. The facsimile apparatus 1003 can receive, via the LAN 1006, data read by the copier 1001 and transmit the received data.

The database/e-mail server 1004 is a server apparatus capable of receiving data read by the copier 1001 via the LAN 1006, and storing the received data as a database or transmitting the received data as an e-mail message.

The client computer 1005 is connected to the database/e-mail server 1004, and thus can obtain desired data therefrom and display the obtained data. Additionally, the client computer 1005 can receive data read by the copier 1001 via the LAN 1006, and can process and edit the received data. The facsimile apparatus 1007 can receive data read by the copier 1001 via the public line 1008 and print and output the received data.

FIG. 2 is a block diagram illustrating a configuration of the copier 1001. The copier 1002 has a configuration similar to that of the copier 1001.

The copier 1001 includes a controller unit 2000. A scanner 2070 serving as an image input device, a printer 2095 serving as an image output device, and an operation unit 2012 are connected to the controller unit 2000. The controller unit 2000 performs control for realizing a copy function which allows image data read by the scanner 2070 to be printed and output by the printer 2095. The controller unit 2000 is connected to the LAN 1006 and the public line 1008 to perform control for input and output of image information and device information. A wide-area network (WAN), which is shown in FIG. 2 as an example of the public line 1008, may be an individual communication line.

The controller unit 2000 includes a central processing unit (CPU) 2001, a random-access memory (RAM) 2002, a read-only memory (ROM) 2003, the HDD 2004, and an image bus interface (I/F) 2005. The controller unit 2000 also includes an operation unit I/F 2006, a network I/F 2010, and a device I/F 2020. The controller unit 2000 further includes an image rotating unit 2030, an image compressing unit 2040, a modem 2050, a raster image processor (RIP) 2060, a scanner image processing unit 2080, and a printer image processing unit 2090.

The CPU 2001, the RAM 2002, the ROM 2003, the HDD 2004, the image bus I/F 2005, the operation unit I/F 2006, the network I/F 2010, and the modem 2050 are connected such that they can communicate with each other via a system bus 2007. Similarly, the image bus I/F 2005, the device I/F 2020, the image rotating unit 2030, the image compressing unit 2040, the RIP 2060, the scanner image processing unit 2080, and the printer image processing unit 2090 are connected such that they can communicate with each other via an image bus 2008.

The CPU 2001 boots an operating system (OS) using a boot program stored in the ROM 2003. An application program stored in the HDD 2004 is executed on the OS. This allows various processes to be performed. The RAM 2002 provides a work area for the CPU 2001. Besides providing a work area, the RAM 2002 provides an image memory area for temporarily storing image data. The HDD 2004 stores application programs and image data.

The operation unit I/F 2006 serves as an interface with the operation unit 2012 having a touch panel and various keys. For example, the operation unit I/F 2006 outputs to the operation unit 2012 image data to be displayed on the operation unit 2012, or sends to the CPU 2001 information input from the operation unit 2012 by the user.

The network I/F 2010 is connected to the LAN 1006, through which the network I/F 2010 inputs and outputs information to and from each apparatus connected to the LAN 1006. The modem 2050 is connected to the public line 1008, through which information is input to and output from the modem 2050.

The image bus I/F 2005 serves as a bus bridge which allows connection between the system bus 2007 and the image bus 2008 for high-speed transmission of image data, and also allows conversion of a data format according to a bus protocol or the like. Examples of the image bus 2008 include a peripheral component interconnect (PCI) bus and an Institute of Electrical and Electronics Engineers (IEEE) 1394-compliant bus.

The RIP 2060 expands PDL code into a bitmap image. The scanner 2070 and the printer 2095 are connected to the device I/F 2020, which performs synchronous/asynchronous conversion of image data.

The scanner image processing unit 2080 corrects, processes, and edits input image data read by the scanner 2070. The printer image processing unit 2090 performs, according to the capability of the printer 2095, correction and resolution conversion on image data to be printed and output from the printer 2095. The image rotating unit 2030 rotates image data. The image compressing unit 2040 compresses multivalued image data into Joint Photographic Experts Group (JPEG) data, and compresses binary image data into Joint Bi-level Image experts Group (JBIG) data, modified-modified READ (MMR) data, or modified Huffman (MH) data. Additionally, the image compressing unit 2040 decompresses JPEG data, JBIG data, MMR data, and MH data.

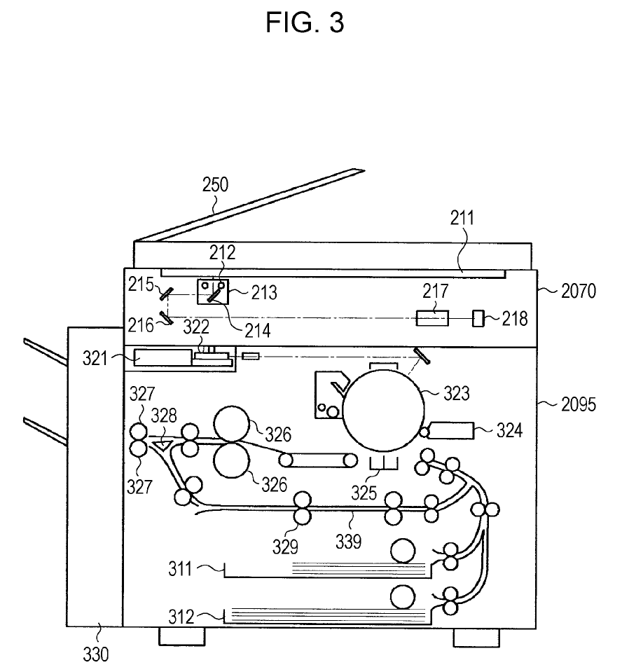

Next, a hardware configuration of the scanner 2070 and printer 2095 will be described with reference to FIG. 3. FIG. 3 is a side cross-sectional view illustrating a hardware configuration of the scanner 2070 and printer 2095 of FIG. 2. As illustrated in FIG. 3, the scanner 2070 and the printer 2095 are configured together as a single unit.

A document feeding unit 250 is mounted on the scanner 2070. The document feeding unit 250 feeds documents one by one from the top onto a glass platen 211. Every time scanning of one document is completed, the document feeding unit 250 ejects the document from the glass platen 211 onto an output tray (not shown).

After a document is fed onto the glass platen 211, the scanner 2070 turns on a lamp 212 and starts movement of a moving unit 213. The movement of the moving unit 213 allows scanning of the document on the glass platen 211. During the scanning, light reflected from the document is guided through mirrors 214, 215, and 216, and a lens 217 to a charge-coupled device image sensor (hereinafter referred to as CCD sensor) 218. Thus, an image on the document is formed on an image pickup surface of the CCD sensor 218. The CCD sensor 218 converts the image formed on the image pickup surface into an electric signal, which is then subjected to predetermined processing and input to a control device (not shown).

The printer 2095 includes a laser driver 321. The laser driver 321 drives a laser emitting unit 322 on the basis of image data input from the control device. Thus, laser light corresponding to the image data is emitted from the laser emitting unit 322. A photosensitive drum 323 is irradiated with the laser light which is being scanned. The laser light forms an electrostatic latent image on the photosensitive drum 323. The electrostatic latent image is formed into a visible toner image with toner supplied from a developing device 324. In synchronization with irradiation of the laser light, a recording sheet is fed between the photosensitive drum 323 and a transfer unit 325 from a cassette 311 or a cassette 312 along a conveying path. The toner image on the photosensitive drum 323 is transferred by the transfer unit 325 onto the fed recording sheet.

The recording sheet on which the toner image has been transferred is sent along a conveying belt to a fixing roller pair (a heating roller and a pressing roller) 326. The fixing roller pair 326 thermally presses the recording sheet to fix the toner image on the recording sheet. The recording sheet, having passed through the fixing roller pair 326, is ejected by an ejection roller pair 327 to a paper output unit 330. The paper output unit 330 is a sheet processing unit capable of performing post-processing, such as sorting and stapling.

When a duplex recording mode is selected, the rotating direction of the ejection roller pair 327 is reversed after the recording sheet reaches the ejection roller pair 327. Then, the recording sheet is guided by a flapper 328 and a roller pair 329 to a refeeding path 339. In synchronization with irradiation of laser light, the recording sheet in the refeeding path 339 is fed again between the photosensitive drum 323 and the transfer unit 325. Then, a toner image is transferred to the back surface of the recording sheet.

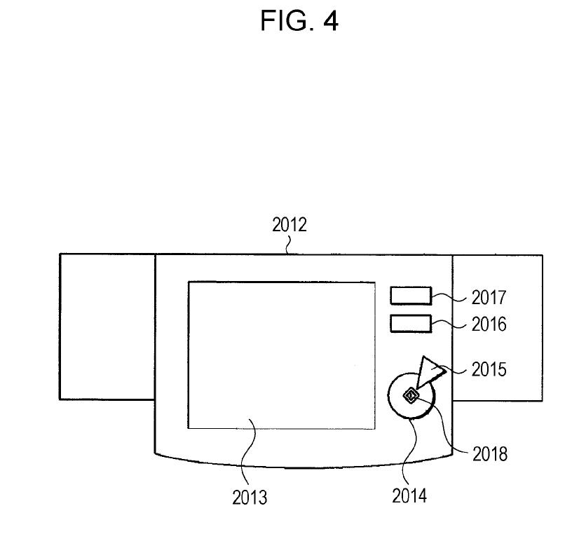

FIG. 4 is a view illustrating a configuration of the operation unit 2012 of FIG. 2. A liquid crystal display (LCD) unit 2013 is an LCD covered with a touch panel sheet thereon. The LCD unit 2013 displays an operation screen for the copier 1001. When a key displayed on the operation screen is pressed, the LCD unit 2013 outputs position information corresponding to the pressed key to the CPU 2001 of the controller unit 2000.

A start key 2014 is used to start scanning a document image. A two-color, green and red, light-emitting diode (LED) 2018 is provided at the center of the start key 2014. The two-color LED 2018 indicates, by its color, whether the start key 2014 is currently enabled. A stop key 2015 is used to stop an operation in progress. An ID key 2016 is used to start an input operation related to a user ID. A reset key 2017 is used to reset settings made through the operation unit 2012.

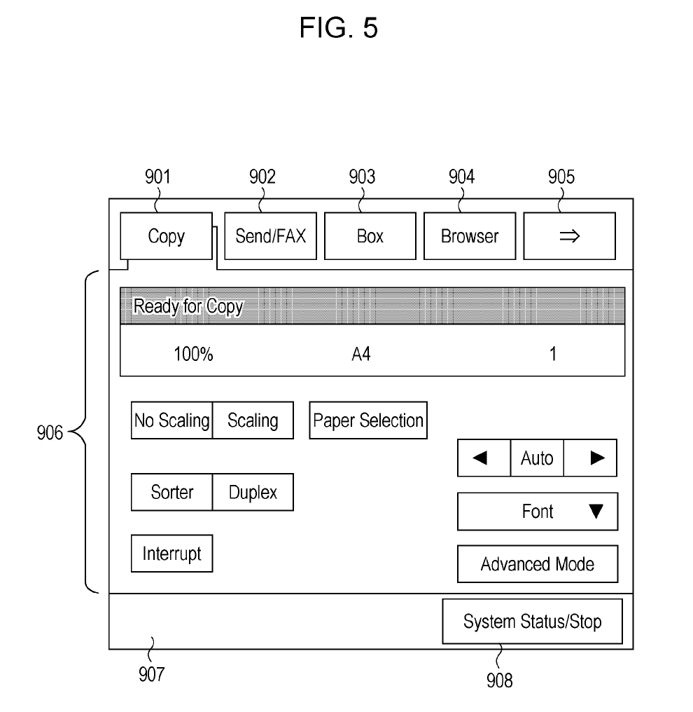

FIG. 5 illustrates an operation screen displayed on the LCD unit 2013 of the operation unit 2012. As illustrated, touch keys for selection of various functions are displayed at the top of the operation screen. The displayed touch keys include a copy tab 901, a send/FAX tab 902, a box tab 903, a browser tab 904, and a right arrow tab 905. The touch keys are not limited to these tabs 901 to 905, which are provided merely as examples.

FIG. 5 illustrates an initial screen for a copy function displayed when the copy tab 901 is pressed. A display region 906 displays information related to the copy function. In the display region 906, an area displaying the message “ready for copy” provides status information for the copy function. An area below this area displays a scaling factor, a selected paper-feed tray, and the number of copies. The display region 906 further displays touch keys for selection of operation modes for the copy function. The displayed touch keys include a “no scaling” key, a “scaling” key, a “paper selection” key, a “sorter” key, a “duplex” key, an “interrupt” key, a “font” key, a left arrow key for reducing the density, a right arrow key for increasing the density, and an “auto” key for automatically adjusting the density. A screen for selection of additional operation modes is hierarchically displayed in the display region 906 by pressing an “advanced mode” key.

A display region 907 displays a status of the copier 1001. For example, the display region 907 displays an alarm message indicating the occurrence of jamming and a status message indicating that PDL printing is in progress. The display region 907 also displays a system status/stop key 908. Pressing the system status/stop key 908 displays a screen which provides device information about the copier 1001, and a screen (not shown) which provides a print job status and allows the user to stop a job in progress.

While not shown, when the send/FAX tab 902, the box tab 903, or the browser tab 904 is pressed, the LCD unit 2013 displays a screen for setting of a function corresponding to the pressed tab. For example, pressing the send/FAX tab 902 displays a setting screen for sending an image read by the copier 1001 to a device on the LAN 1006 by e-mail transmission, by file transfer protocol (FTP) transmission, or by fax via the public line 1008. Pressing the box tab 903 displays a setting screen for storing an image read by the copier 1001 in a box area of the HDD 2004, printing specified image data stored in a box area, or sending the image data to a device on the LAN 1006.

For example, when the copier 1001 has five or more functions, the right arrow tab 905 is displayed to the right of the four function tabs (i.e., copy, send/FAX, box, and browser tabs 901 to 904). Then when the right arrow tab 905 is pressed, a screen for another function is displayed.

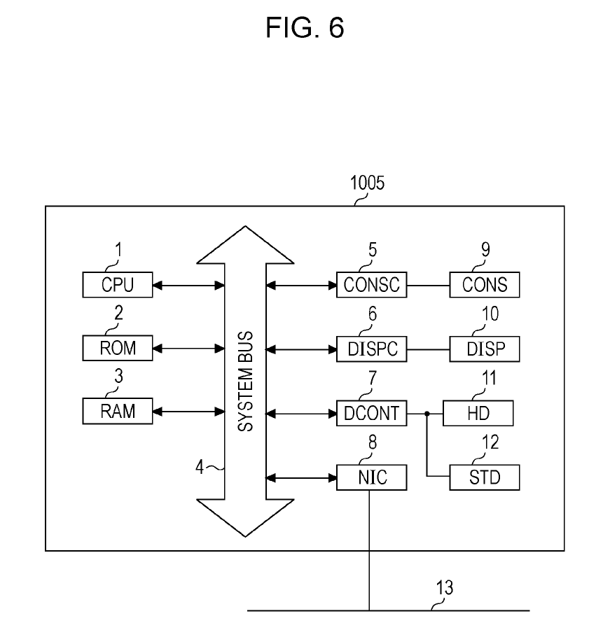

FIG. 6 is a block diagram illustrating a configuration of the client computer 1005. The client computer 1005 includes a CPU 1, a ROM 2, and a RAM 3. The client computer 1005 also includes a controller (CONSC) 5 for an operation unit (CONS) 9 including a keyboard and a mouse. The client computer 1005 further includes a display controller (DISPC) 6 for a display (DISP) 10 serving as a display unit, such as a cathode-ray tube (CRT) or an LCD. Additionally, the client computer 1005 includes a controller (DCONT) 7 for a storage device (STD) 12, such as a hard disk (HD) 11 or a floppy disk, and a network interface card (NIC) 8. Functional units 1, 2, 3, 5, 6, 7, and 8 are connected such that they can communicate with each other via a system bus 4.

The CPU 1 executes a software program stored in the ROM 2 or HD 11 or supplied from the STD 12 to collectively control all components connected to the system bus 4. In other words, the CPU 1 reads a processing program for performing various operations from the ROM 2, the HD 11, or the STD 12 and executes the read processing program, thereby performing control for realizing the operations. The RAM 3 serves as a main memory or a work area for the CPU 1.

The CONSC 5 controls an instruction input from the CONS 9. The DISPC 6 controls display of the DISP 10. The DCONT 7 controls access to and from the HD 11 and STD 12 storing a boot program, various application programs, user files, a network management program, and various processing programs. The NIC 8 sends and receives data to and from other devices on a network 13.

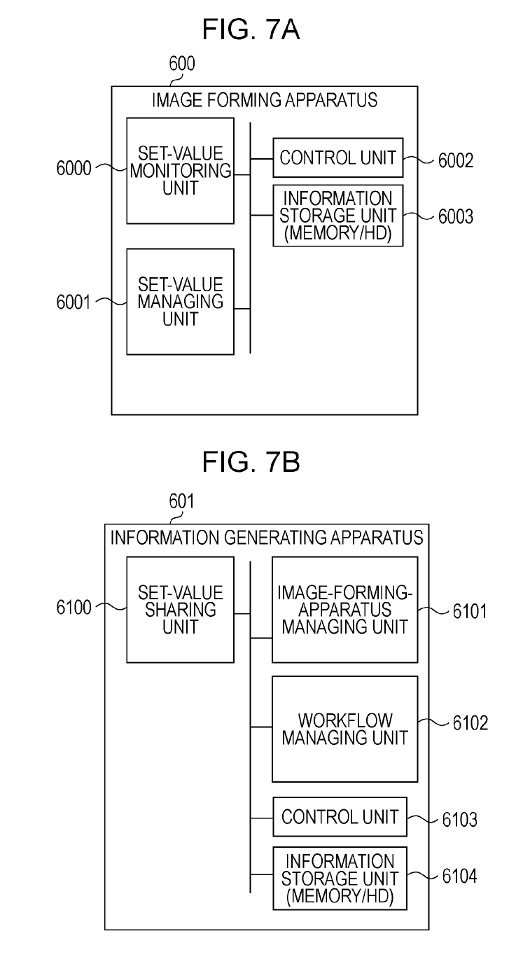

FIG. 7A and FIG. 7B are block diagrams illustrating configurations of an image forming apparatus 600 and an information generating apparatus 601 according to the present embodiment. FIG. 7A and FIG. 7B illustrate components for realizing functions described below and omit illustration of the other components (e.g., components for realizing image forming functions).

The image forming apparatus 600 of FIG. 7A is a multifunction apparatus which provides a desired function to a user. Examples of the image forming apparatus 600 include the copier 1001 and the copier 1002. The information generating apparatus 601 is an information processing apparatus, such as the client computer 1005.

As illustrated in FIG. 7A, the image forming apparatus 600 includes a set-value monitoring unit (serving as a transmitting unit and a monitoring unit) 6000, a set-value managing unit (serving as a managing unit) 6001, a control unit (serving as a transmitting unit, a monitoring unit, and a managing unit) 6002, and an information storage unit (memory/HD) 6003.

The set-value monitoring unit 6000 monitors set values for each workflow (processing flow) executed for each user and provides the set values to the information generating apparatus 601. Specifically, the set-value monitoring unit 6000 recognizes set values set, by user operation, for a workflow including a plurality of processing steps. Upon completion of all processing steps in the workflow, the set-value monitoring unit 6000 obtains set values (first set value information) set for executing the workflow and passes the set values to the information generating apparatus 601 together with flow information about the workflow.

The set-value managing unit 6001 manages options selected and information entered by the user for executing a plurality of processing steps in a workflow. The options selected and information entered may be collectively referred to as set value information. That is, the set-value managing unit 6001 manages set values set for executing a plurality of processing steps in a workflow and provides the set values to the set-value monitoring unit 6000.

The control unit 6002 controls processing of each function. That is, the control unit 6002 manages and calls various functions. The information storage unit 6003 is a database for storing necessary information. Here, the information storage unit 6003 has a configuration similar to that of the HDD 2004 (see FIG. 2). However, the information storage unit 6003 may have a configuration similar to that of any storage medium, such as a semiconductor memory.

The set-value monitoring unit 6000, the set-value managing unit 6001, and the control unit 6002 are realized when, for example, the CPU 2001 executes an application program stored in the HDD 2004. In other words, the functions of the transmitting unit, managing unit, and monitoring unit according to an embodiment of the present invention are realized by the CPU 2001 which executes an application program stored in the HDD 2004.

As illustrated in FIG. 7B, the information generating apparatus 601 includes a set-value sharing unit (serving as an information generating unit and a holding unit) 6100, an image-forming-apparatus managing unit (serving as an apparatus managing unit) 6101, and a workflow managing unit 6102. The information generating apparatus 601 further includes a control unit (serving as an information generating unit, a holding unit, and a set-value sharing unit) 6103 and an information storage unit (memory/HD) 6104.

When set values are supplied from the set-value monitoring unit 6000, the set-value sharing unit 6100 generates set value information that can be used in an external image forming apparatus (second image forming apparatus) by the user. Specifically, upon receipt of set values (first set value information) from the set-value monitoring unit 6000, the set-value sharing unit 6100 generates set value information (second set value information) according to the function and capability of an external image forming apparatus (second image forming apparatus) based on the received set values (first set value information). Here, the set-value sharing unit 6100 obtains information about the external image forming apparatus (second image forming apparatus) from the image-forming-apparatus managing unit 6101 and refers to the obtained information to generate the set value information (second set value information). Since an image forming apparatus executes workflows, it may be referred to as a workflow executing apparatus.

The image-forming-apparatus managing unit 6101 manages information, for example, about functions and capabilities of image forming apparatuses executing workflows. The workflow managing unit 6102 manages the types of workflows used by the user. Additionally, the workflow managing unit 6102 manages a default set value for each of a plurality of processing steps in each workflow.

The control unit 6103 controls processing of each function. That is, the control unit 6103 manages and calls various functions. The information storage unit 6104 stores necessary information. As in the case of the information storage unit 6003, the information storage unit 6104 has a configuration similar to that of, for example, the HD 11 (see FIG. 6). However, the information storage unit 6104 may have a configuration similar to that of any storage medium, such as a semiconductor memory.

The set-value sharing unit 6100, the image-forming-apparatus managing unit 6101, the workflow managing unit 6102, and the control unit 6103 are realized when, for example, the CPU 1 executes an application program stored in the HD 11. In other words, the functions of the information generating unit, holding unit, and apparatus managing unit according to an embodiment of the present invention are realized by the CPU 1 which executes an application program stored in the HD 11.

The information generating apparatus 601, which has been described as the client computer 1005, may be the image forming apparatus 600. In this case, the control unit 6002 of the image forming apparatus 600 and the control unit 6103 of the information generating apparatus 601 may be realized by a single control unit such that the functions of both the control unit 6002 and the control unit 6103 are provided by the single control unit. Similarly, the information storage unit 6003 of the image forming apparatus 600 and the information storage unit 6104 of the information generating apparatus 601 may be realized by a single information storage unit such that the functions of both the information storage unit 6003 and the information storage unit 6104 are provided by the single information storage unit.

Therefore, when a workflow executing apparatus performs processing of both the image forming apparatus 600 and the information generating apparatus 601, the functions of both the apparatuses are realized by the set-value monitoring unit 6000, the set-value managing unit 6001, the set-value sharing unit 6100, the image-forming-apparatus managing unit 6101, the workflow managing unit 6102, a control unit, and an information storage unit. A processing flow (described below) performed with this configuration is the same as that in the case where the image forming apparatus 600 is a copier and the information generating apparatus 601 is a client computer.

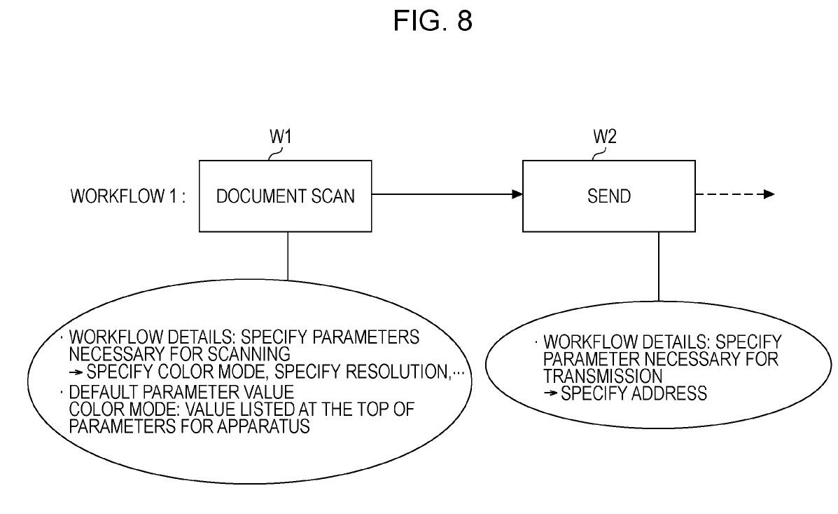

FIG. 8 illustrates a workflow according to an embodiment of the present invention. As illustrated, “workflow 1” includes document scan W1 (first processing step) and send W2 (second processing step). Document scan W1 involves execution of so-called scanning, which uses functions provided by the scanner 2070 (see FIGS. 2 and 3). Send W2 involves execution of electronic data transmission performed by selecting the send/FAX tab 902 (see FIG. 5).

Document scan W1 requires specification of parameters necessary for scanning. Examples of the parameters for scanning in the present embodiment include color mode and resolution. As for color mode, a parameter listed at the top of parameter options for the apparatus is set to be used as a default parameter value. Send W2 requires specification of a parameter necessary for data transmission. The necessary parameter is an address used for data transmission.

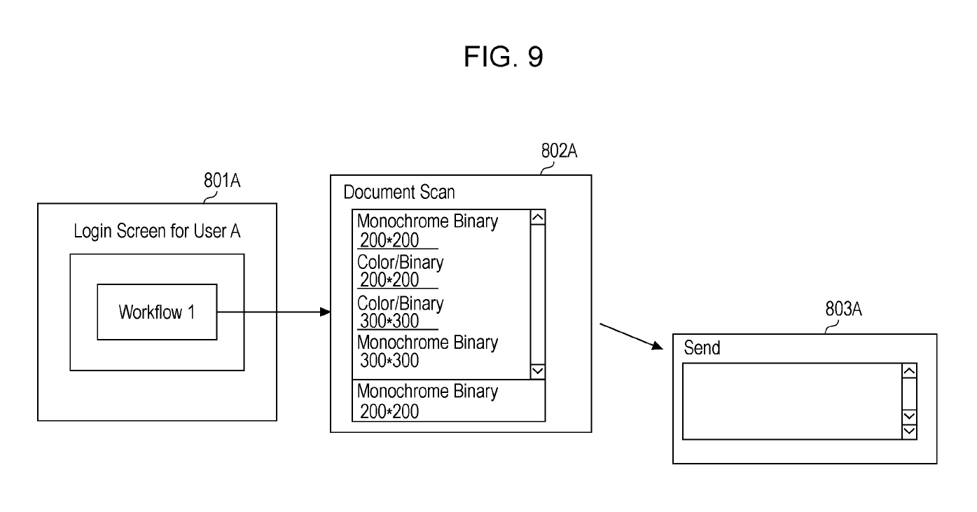

Next, there will be described screens displayed when a workflow actually operates. FIG. 9 illustrates an initial state of screens displayed when “workflow 1” of FIG. 8 is distributed to a user A's environment provided in the image forming apparatus 600 (first workflow executing apparatus). That is, FIG. 9 illustrates screens displayed when a workflow is executed according to a default set value.

A login screen 801A is a menu screen displayed when the user A logs in to the first workflow executing apparatus. The login screen 801A provides “workflow 1” in a selectable state. This means that a workflow available to the user A is “workflow 1”. It is to be understood that if another user logs in to the first workflow executing apparatus, a workflow available to this user is displayed. When “workflow 1” is selected by a user operation, such as pressing of a touch key, the process proceeds to document scan W1 (first processing step). Document scan W1 requires specification of a color mode. As described with reference to FIG. 8, a default parameter is specified to be used for the color mode. In FIG. 9, a default set value (listed at the top of the option list) for the color mode in the first workflow executing apparatus is “monochrome binary 200*200”. Therefore, as shown in a setting screen 802A, “monochrome binary 200*200” at the top of the option list is selected in the initial state. Then, the process proceeds to send W2 (second processing step). Since no destination address is added as a candidate for entry, an empty list is displayed on a setting screen 803A.

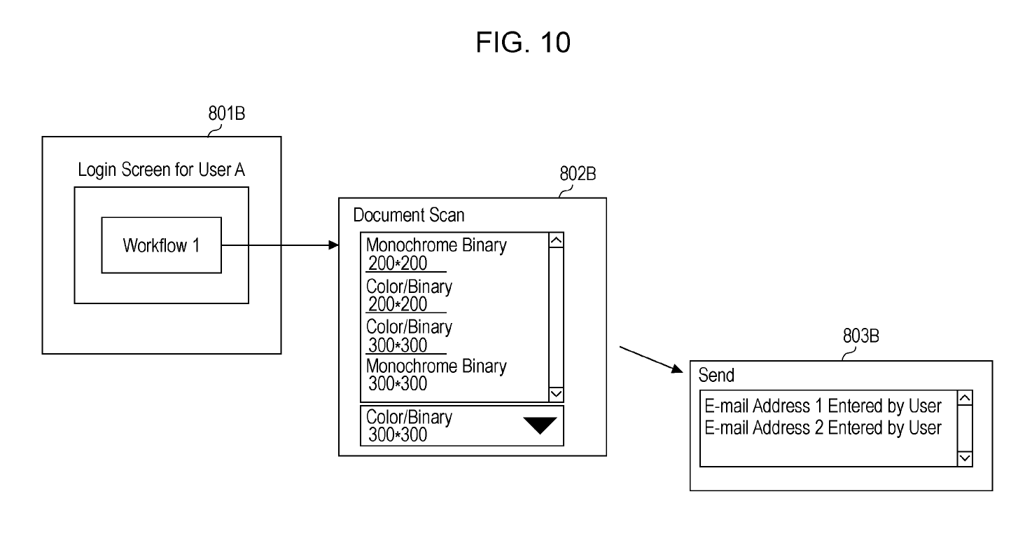

FIG. 10 illustrates screens on which the user A performs a setting process to execute a workflow in the image forming apparatus 600 (first workflow executing apparatus). A copier which provides a workflow includes a color scanner.

In a login screen 801B, when “workflow 1” is selected by a user operation, such as pressing of a touch key, the process proceeds to document scan W1 (first processing step). In document scan W1, the user A selects “color/binary 300*300” on a setting screen 802B for execution of color scanning. Upon completion of the selection of “color/binary 300*300” in document scan W1, the process proceeds to send W2 (second processing step). In send W2, as shown in a setting screen 803B, the user A enters destination address candidates. After entering the destination address candidates “e-mail address 1 entered by user” and “e-mail address 2 entered by user”, the user A selects at least one destination address. Completion of the above-described steps allows setting of the workflow to complete. Then, the workflow is executed using the set values.

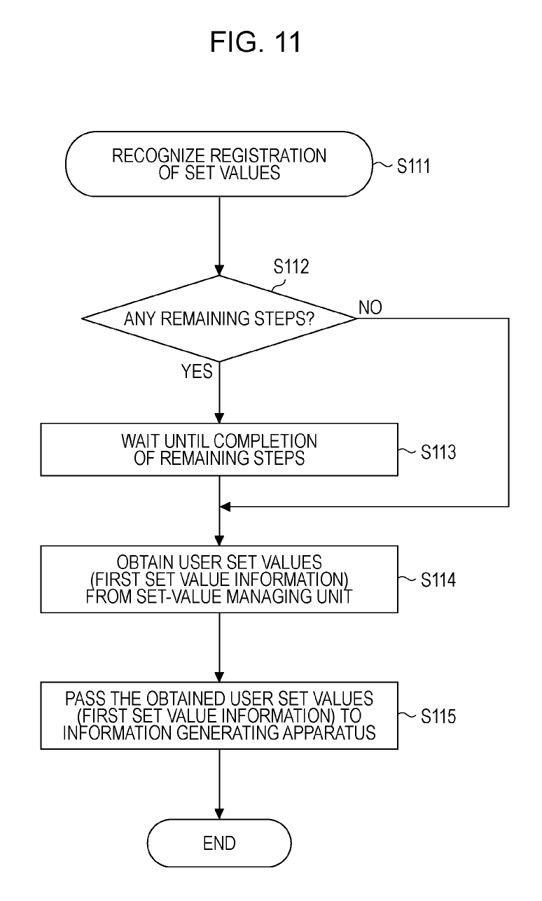

FIG. 11 is a flowchart illustrating a set-value-information providing process in which the image forming apparatus 600 (first workflow executing apparatus) provides set values (first set value information) for each workflow (processing flow) executed on a user-by-user basis to the information generating apparatus 601.

In step S111, where a user's workflow starts, the control unit 6002 of the image forming apparatus 600 calls the set-value monitoring unit 6000 to obtain information indicating whether registration of set values for the workflow is recognized. If registration of set values is recognized, the control unit 6002 initiates the set-value-information providing process. In step S112, the control unit 6002 inquires of the set-value monitoring unit 6000 whether there are any remaining steps in the user's workflow. If there are any remaining steps, the process proceeds to step S113. If no step remains, the process proceeds to step S114.

In step S113, the control unit 6002 inquires of the set-value monitoring unit 6000 about the time of completion of the remaining steps in the user's workflow. According to the response from the set-value monitoring unit 6000, the control unit 6002 waits until completion of the remaining steps.

After completion of all steps in the user's workflow, the control unit 6002 obtains, in step S114, set values (first set value information) set by the user for execution of the workflow. Specifically, the control unit 6002 sends an inquiry to the set-value managing unit 6001 for obtaining the first set value information. Then, the control unit 6002 obtains the first set value information from the set-value managing unit 6001. In FIG. 11, the operation of step S114 is performed after registration of set values for all processing steps. However, the operation of step S114 may be performed after execution of all processing steps in the workflow. If the operation of step S114 is performed after execution of all processing steps in the workflow, set values that have been confirmed to ensure proper execution of the workflow can be delivered for a second workflow executing apparatus.

In step S115, the control unit 6002 passes, to the set-value managing unit 6001 of the information generating apparatus 601, the obtained user set values (first set value information) together with flow information about the executed workflow.

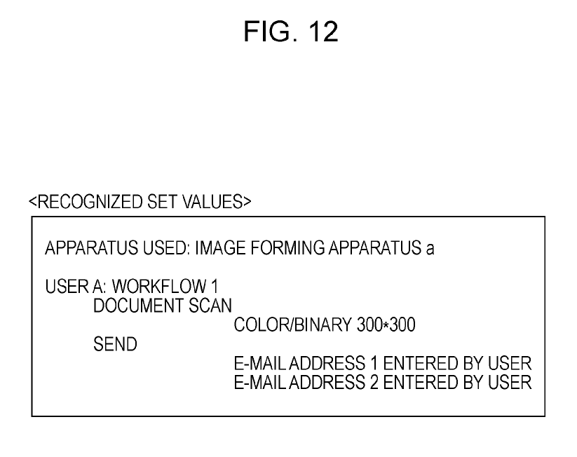

FIG. 12 illustrates an example of the first set value information provided to the set-value managing unit 6001 of the information generating apparatus 601 in step S115. The first set value information provided to the set-value managing unit 6001 includes information about the first workflow executing apparatus in which the registration of set values is recognized and information about set values for executing a user's workflow. The information for executing the workflow is information about set values set on the setting screens illustrated in FIG. 10. FIG. 12 illustrates an example of set value information set in the manner illustrated in FIG. 10. FIG. 12 indicates that, for execution of “workflow 1”, the user A has selected “color/binary 300*300” for a “document scan” step and entered “e-mail address 1” and “e-mail address 2” for a “send” step.

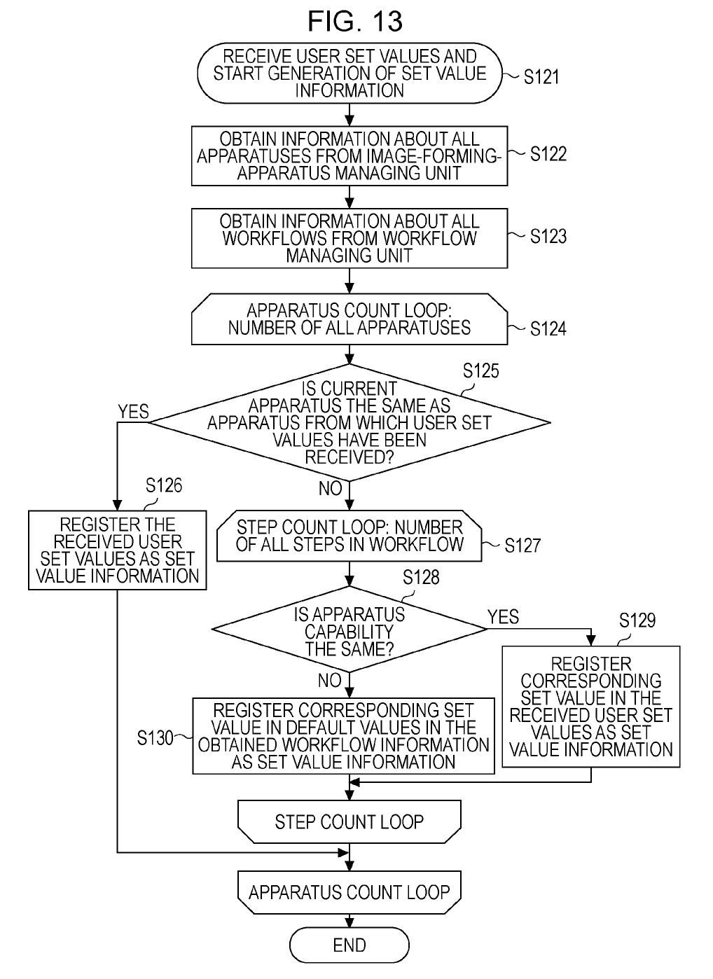

FIG. 13 is a flowchart illustrating an information generating process in which set value information for allowing another apparatus to execute the same workflow as that described above is generated based on the first set value information provided by the set-value-information providing process described above.

In step S121, the control unit 6103 of the information generating apparatus 601 calls the set-value sharing unit 6100 to check whether the first set value information has been received from the image forming apparatus 600. If the first set value information has been received, the control unit 6103 initiates the information generating process. That is, generation of second set value information based on the first set value information is started. As described above, the information generating apparatus 601 obtains (receives) the first set value information after completion of the processing flow in the first workflow executing apparatus which provides the first set value information.

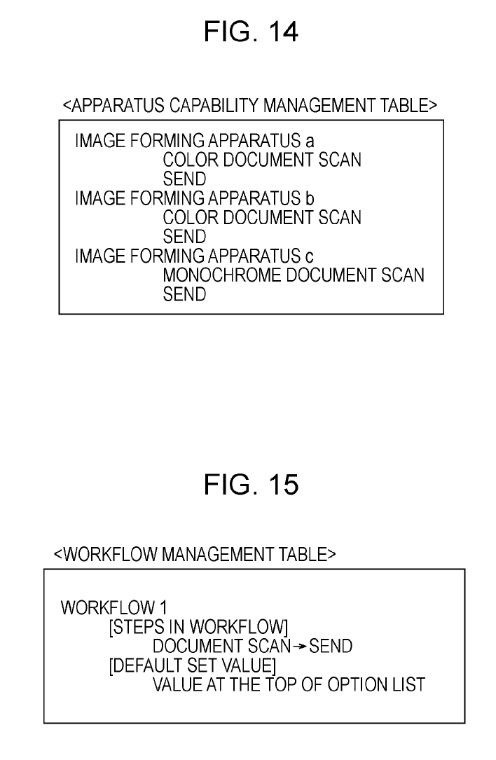

In step S122, the control unit 6103 obtains information about all image forming apparatuses managed by the image-forming-apparatus managing unit 6101. FIG. 14 illustrates functional information (apparatus capability management table) related to image forming apparatuses managed by the image-forming-apparatus managing unit 6101. The apparatus capability management table contains functional information about capability of each image forming apparatus. In the example of FIG. 14, the apparatus capability management table manages an image forming apparatus “a”, an image forming apparatus “b”, and an image forming apparatus “c”. The functional information about capability of each image forming apparatus is information as to whether the image forming apparatus is capable of scanning a color or monochrome document and has a send function. The apparatus capability management table is stored in the information storage unit 6104.

In step S123, the control unit 6103 obtains information about all workflows managed by the workflow managing unit 6102. FIG. 15 illustrates information (workflow management table) related to a workflow managed by the workflow managing unit 6102. In the example of FIG. 15, the workflow management table manages information about “workflow 1”. As shown, the information about “workflow 1” includes information about “steps in workflow” and “default set value”. “Steps in workflow” indicates that the steps in workflow 1 correspond to document scan W1 (first processing step) and send W2 (second processing step). “Default set value” indicates that a value listed at the top of an option list is a default set value. The workflow management table is stored in the information storage unit 6104.

In step S124, the control unit 6103 causes the process to enter a loop (apparatus count loop) in which a series of steps is executed by a number of all image forming apparatuses based on the information obtained in step S122.

In step S125, it is determined whether the image forming apparatus (second workflow executing apparatus) for which the second set value information is to be generated is the same as the image forming apparatus (first workflow executing apparatus) which has provided the first set value information. If the second workflow executing apparatus is the same as the first workflow executing apparatus, the process proceeds to step S126, and if not, the process proceeds to step S127.

In step S126, the control unit 6103 uses the received first set value information to generate set value information, and requests the set-value sharing unit 6100 to register the generated set value information. Upon receipt of the request for registration, the set-value sharing unit 6100 stores the set value information in the information storage unit 6104.

In step S127, the control unit 6103 causes the process to enter a loop (step count loop) in which a series of steps is executed by a number of all steps in every workflow based on the workflow information obtained in step S123.

In step S128, the control unit 6103 determines whether capability of the image forming apparatus (second workflow executing apparatus), the capability being specified in the step of the workflow, is the same as the capability of the image forming apparatus (first workflow executing apparatus) which has provided the first set value information. If these capabilities are the same, the process proceeds to step S129, and if not (i.e., if a set value corresponding to the first set value information cannot be set), the process proceeds to step S130. For example, in step S128, if the first step in the workflow is an image scanning step, the control unit 6103 determines whether both the image forming apparatus (first workflow executing apparatus) which has provided the first set value information and the image forming apparatus (second workflow executing apparatus) for which the second set value information is to be generated are capable of realizing the same image scanning.

In step S129, the control unit 6103 uses a set value for the corresponding step in the first set value information to generate second set value information. Then, the control unit 6103 requests the set-value sharing unit 6100 to register the generated second set value information. Upon receipt of the request for registration, the set-value sharing unit 6100 stores the second set value information in the information storage unit 6104.

On the other hand, in step S130, the control unit 6103 uses a default value in the workflow information obtained from the workflow managing unit 6102 to generate second set value information, and requests the set-value sharing unit 6100 to register the generated second set value information. Upon receipt of the request for registration, the set-value sharing unit 6100 stores the second set value information in the information storage unit 6104. In the present embodiment, a default value for the corresponding step in the obtained workflow information is used to generate second set value information. However, a default value (initial value) for the corresponding step in the image forming apparatus (second workflow executing apparatus) for which second set value information is to be generated may be used to generate the second set value information.

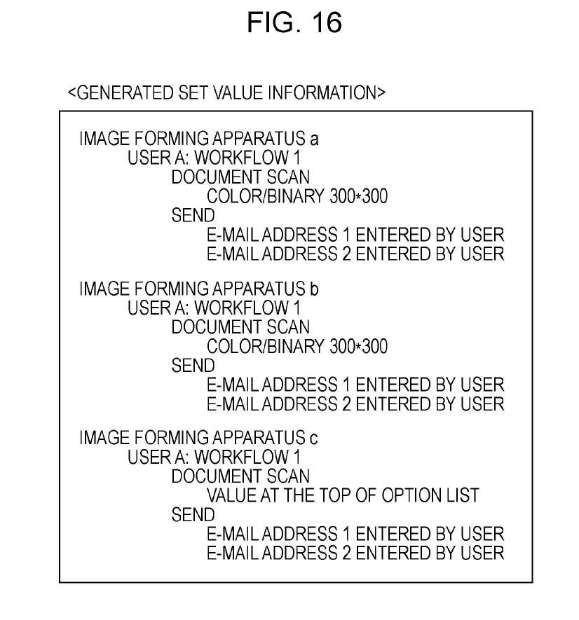

FIG. 16 illustrates an example of set value information generated and registered in the information generating process described above. In the set value information illustrated in FIG. 16, the image forming apparatus “a” which has provided the first set value information is the same as the image forming apparatus “a” managed in the apparatus capability management table. Therefore, the first set value information illustrated in FIG. 12 is registered in the image forming apparatus “a” (step S126). The image forming apparatus “b” and the image forming apparatus “a” are different apparatuses but have the same function. Therefore, the first set value information illustrated in FIG. 12 is registered (step S129). The image forming apparatus “c” and the image forming apparatus “a” are different in scanning function. Therefore, information “value at the top of option list” shown in FIG. 16 is registered (step S130).

The image forming apparatus “b” and the image forming apparatus “c” obtain the second set value information upon being notified that the second set value information has been registered by the set-value sharing unit 6100 in the information generating process described above. Thus, the set value information set by the user in the image forming apparatus “a” for executing a workflow is inherited to the image forming apparatus “b” and the image forming apparatus “c”.

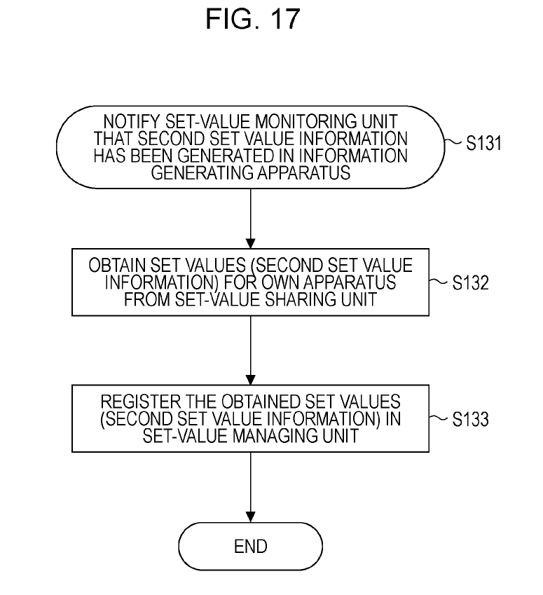

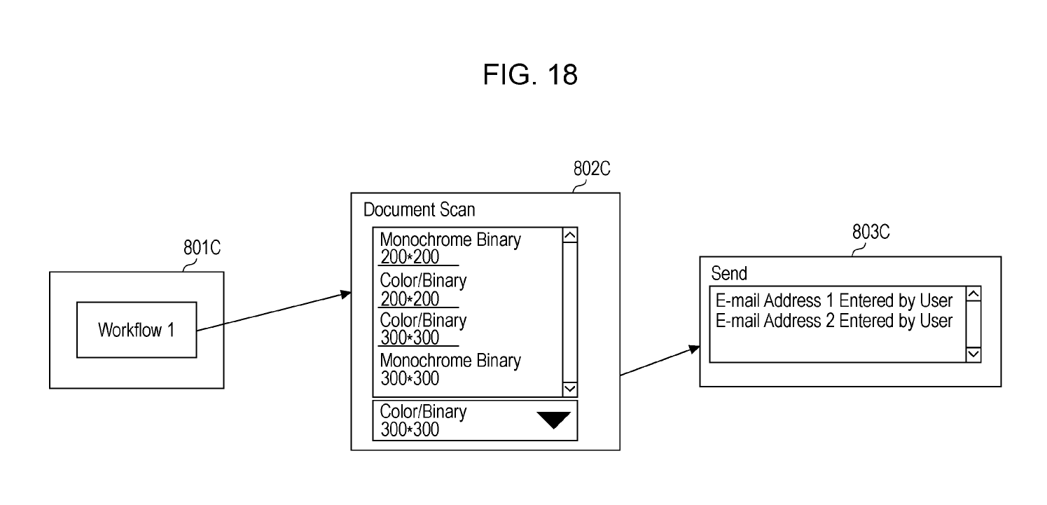

FIG. 17 is a flowchart illustrating a set-value-information obtaining process in which the image forming apparatus 600 obtains the second set value information generated in the information generating process described above. The process illustrated in FIG. 17 is performed by an image forming apparatus different from the image forming apparatus which has provided the first set value information.

In step S131, the control unit 6002 of the image forming apparatus 600 calls the set-value monitoring unit to check whether the set-value monitoring unit 6000 has been notified that the second set value information for the own apparatus has been registered in the information generating apparatus 601. If the set-value monitoring unit has been notified, the control unit 6002 starts the process.

In step S132, the control unit 6002 obtains the second set value information for the own apparatus from the set-value sharing unit 6100. In step S133, the control unit requests the set-value managing unit 6001, via the set-value monitoring unit 6000, to register the obtained second set value information. Upon receipt of the request for registration, the set-value managing unit 6001 stores the obtained second set value information in the information storage unit 6104.

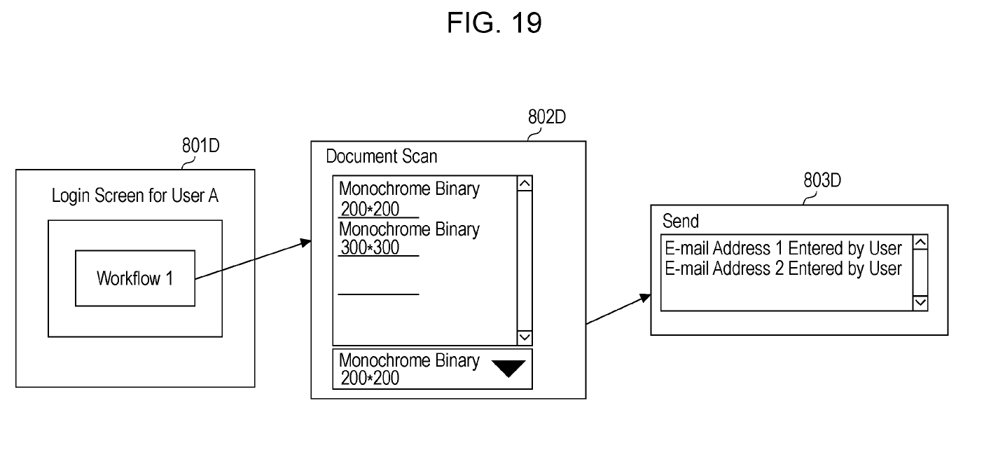

FIG. 18 and FIG. 19 illustrate screens displayed when a workflow (workflow 1) is executed in the image forming apparatuses “b” and “c” after the set-value-information obtaining process described above is performed.

FIG. 18 illustrates screens displayed when the user A executes “workflow 1” in the image forming apparatus “b”. Of the second set value information generated for all image forming apparatuses for the user A in the information generating process described above, set values (second set value information) for the image forming apparatus “b” are inherited to the image forming apparatus “b”. Here, the capability of the image forming apparatus “b” is the same as that of the image forming apparatus “a”. The user A is a user who has set the set values shown in FIG. 12.

In the example of FIG. 18, in the image forming apparatus “b”, when the user A selects “workflow 1” by operating a touch key or the like on a login screen 801C, the process proceeds to document scan W1 (first processing step). On a setting screen 802C for document scan W1, “color/binary 300*300” is already selected based on the second set value information. Then, the process proceeds to send W2 (second processing step). On a setting screen 803C for send W2, “e-mail address 1 entered by user” and “e-mail address 2 entered by user” are already input as destination candidates on the basis of the second set value information. Therefore, for execution of the workflow, for example, the user does not have to reselect a color value for document scanning, and also is saved the trouble of entering destination candidates for transmission.

FIG. 19 illustrates screens displayed when the user A executes “workflow 1” in the image forming apparatus “c”. Of the second set value information generated for all image forming apparatuses in the information generating process described above, set values (second set value information) for the image forming apparatus “c” is inherited to the image forming apparatus “c”. The image forming apparatus “c” has a document scan capability different from that of the image forming apparatus “a”, but has the same send capability as that of the image forming apparatus “a”.

In the example of FIG. 19, in the image forming apparatus “c”, when the user A selects “workflow 1” by operating a touch key or the like on a login screen 801D, the process proceeds to document scan W1 (first processing step). On a setting screen 802D for document scan W1, a default value “monochrome binary 200*200” for the image forming apparatus “c” is already selected on the basis of the second set value information. Then, the process proceeds to send W2 (second processing step). On a setting screen 803D for send W2, “e-mail address 1 entered by user” and “e-mail address 2 entered by user” are already input as destination candidates on the basis of the second set value information. Therefore, even if capabilities of two image forming apparatuses are different from each other, a set value that can be inherited is inherited from one image forming apparatus to another, and only a set value that cannot be inherited is, for example, replaced with a default value. Thus, in executing a workflow, the user can be saved the trouble of selecting a value from options and entering input candidates.

In the present embodiment described above, based on the set value information set for executing a workflow in one image forming apparatus, set value information for executing the same workflow in another image forming apparatus is generated and provided according to the capability of the image forming apparatus. Thus, in processing steps in the workflow, there is no need for the user to select and enter set values, and the user can be saved the trouble of reselecting and entering set values. Therefore, it is possible to reduce the number of user operations necessary to execute workflows in apparatuses distributed in different environments.

Additionally, since a set value in each processing step in a workflow is inherited as a set value actually used, an item always selected in routine work can be selected and an input item often selected is easily selectable. Thus, since there is no need to reselect a set value in every processing step, the user can be saved the trouble of data entry.

With the present embodiment, there is no need for the user to reselect set values and, at the same time, an external workflow executing apparatus can properly execute a workflow.

### Other Embodiments

To cause various devices to operate for realizing the functions of the above-described embodiments, a software program for realizing the functions of the above-described embodiments is supplied to a computer (CPU or microprocessing unit (MPU)) in an apparatus or a system connected to the various devices. Then, the computer of the apparatus or system causes the various devices to operate according to the program stored in the computer. This implementation is also included in the scope of the present invention.

In this case, the software program itself realizes the functions of the above-described embodiments and constitutes the present invention. A means for supplying the program to the computer, for example, a storage medium storing such a program therein also constitutes the present invention. Examples of the storage medium storing such a program include a floppy disk, a hard disk, an optical disk, a magneto-optical disk, a compact-disk read-only memory (CD-ROM), a magnetic tape, a nonvolatile memory card, and a ROM.

Additionally, the functions of the above-described embodiments may be realized by a supplied program cooperating with an operating system (OS) running on the computer, other application software, or the like. It is to be understood that such a program is also included in the embodiments of the present invention.

After the supplied program is stored in a memory in a function expansion board or a function expansion unit of the computer, a CPU in the function expansion unit or the like performs all or part of actual processing according to instructions of the program. It is to be understood that the implementation where this processing realizes the functions of the above-described embodiments is also included in the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-235844 filed Sep. 11, 2007, which is hereby incorporated by reference herein in its entirety.

What is claimed is:

1. An information processing apparatus that communicates with a plurality of workflow executing apparatuses capable of executing a processing flow including a plurality of processing steps, the information processing apparatus comprising:
a managing unit configured to manage functional information about the plurality of workflow executing apparatuses;
an obtaining unit configured to obtain a first set value information for executing the processing flow in a first workflow executing apparatus; and
a generating unit configured to generate, when a second workflow executing apparatus executes the processing flow, a second set value information for the second workflow executing apparatus based on the first set value information,
wherein, when the second workflow executing apparatus cannot execute processing corresponding to the first set value information, the generating unit generates the second set value information based on the first set value information and functional information about the second workflow executing apparatus.

2. The information processing apparatus according to claim 1, further comprising a transmitting unit configured to transmit, to the second workflow executing apparatus, flow information about the processing flow and the second set value information.

3. The information processing apparatus according to claim 1, wherein the obtaining unit obtains the first set value information after the processing flow is executed by the first workflow executing apparatus.

4. A method for controlling an information processing apparatus that communicates with a plurality of workflow executing apparatuses capable of executing a processing flow including a plurality of processing steps, the method comprising:
managing functional information about the plurality of workflow executing apparatuses;
obtaining a first set value information for executing the processing flow in a first workflow executing apparatus; and
generating, when a second workflow executing apparatus executes the processing flow, a second set value information for the second workflow executing apparatus based on the first set value information,
wherein, when the second workflow executing apparatus cannot execute processing corresponding to the first set value information, the second set value information is generated based on the first set value information and functional information about the second workflow executing apparatus.

5. The method according to claim 4, further comprising transmitting, to the second workflow executing apparatus, flow information about the processing flow and the second set value information.

6. The method according to claim 4, wherein the first set value information is obtained after the processing flow is executed by the first workflow executing apparatus.

7. A program stored on a computer-readable storage medium and executed by an information processing apparatus that communicates with a plurality of workflow executing apparatuses capable of executing a processing flow including a plurality of processing steps, the program comprising:
managing functional information about the plurality of workflow executing apparatuses;
obtaining a first set value information for executing the processing flow in a first workflow executing apparatus; and
generating, when a second workflow executing apparatus executes the processing flow, a second set value information for the second workflow executing apparatus based on the first set value information,
wherein, when the second workflow executing apparatus cannot execute processing corresponding to the first set value information, the second set value information is generated based on the first set value information and functional information about the second workflow executing apparatus.

8. The program according to claim 7, further comprising transmitting, to the second workflow executing apparatus, flow information about the processing flow and the second set value information.

9. The program according to claim 7, wherein the first set value information is obtained after the processing flow is executed by the first workflow executing apparatus.
